(19) United States
(12) Patent Application Publication
(10) Pub. No.: US 2012/0151504 A1
(43) Pub. Date: Jun. 14, 2012

(54) METHOD FOR CREATING A CUSTOMER-SPECIFIC SETUP FOR A LIBRARY OF DEVICE DRIVERS

(75) Inventors: Alexander Schwalbe, Pforzheim (DE); Michael Gunzert, Herxheim (DE); Immanuel Vetter, Sinzheim (DE)

(73) Assignee: CodeWrights GmbH, Karlsruhe (DE)

(21) Appl. No.: 13/315,564

(22) Filed: Dec. 9, 2011

(30) Foreign Application Priority Data
Dec. 10, 2010 (DE) 10 2010 062835. 2

(51) Int. Cl. G06F 9/445; G06F 17/30

(52) U.S. Cl. 719/321

(57) ABSTRACT

A method for creating a customer-specific setup for a library of device drivers, wherein each device driver is a software module, via which a field device, or a field device type, can be serviced. The method permits creation of an individualized, customer-specific setup for the device driver library. This is achieved by the feature that a DTM library setup is expanded automatically by earlier assembled, customer-specific information.

The invention relates to a method for creating a customer-specific setup for a library of device drivers, wherein each device driver is a software module, via which a field device, or a field device type, can be serviced.

In process—as well as in manufacturing-automation technology, field devices are often applied, which serve for registering and/or influencing process variables. Serving for registering process variables are measuring devices, such as, for example, fill level measuring devices, flow measuring devices, pressure- and temperature measuring devices, pH-measuring devices, conductivity measuring devices, etc., which register the corresponding process variables, fill level, flow, pressure, temperature, pH-value, or conductivity. Used for influencing process variables are actuators, such as valves or pumps, via which e.g. the flow of a liquid in a pipeline or the fill level of a medium in a container is changed. Thus, in connection with the invention, the term ‘field devices’ refers to all types of measuring devices and actuators.

In connection with the invention, the term ‘field devices’ refers, moreover, also to all devices, which are applied near to the process and which deliver, or process, process relevant information. Besides the earlier named measuring devices/sensors and actuators, also referred to as field devices are generally any units, which are connected directly to a fieldbus and which serve for communication with the superordinated unit. Thus, units such as remote I/Os, gateways, linking devices and wireless adapters, or radio adapters are also field devices. A large number of such field devices are available from the Endress+Hauser group of companies.

In modern industrial plants, communication between at least one superordinated control unit and the field devices occurs, as a rule, via a bus system, such as, for example, Profibus® PA, Foundation Fieldbus® or HART®. The bus systems can be embodied both hardwired as well as also wirelessly. The superordinated control unit serves for process control, process visualizing, process monitoring as well as for the start-up and servicing of field devices and is also referred to as a configuration/management system.

The integration of field devices in configuration- or management systems occurs via device descriptions, which enable that the superordinated control units, or servicing units, can detect and interpret the data delivered from the field devices. Device descriptions for each field device type, or for each field device type in different applications, are, as a rule, provided by the respective device manufacturer. In order that the field devices can be integrated in different fieldbus systems, different device descriptions for the different fieldbus systems must be created. Thus there are—in order to name only some examples—HART-, Fieldbus Foundation- and Profibus device descriptions. The number of device descriptions is very large and corresponds to the large number of different field devices, or field device types, in different applications and bus systems.

For the purpose of creating a unitary description language for field devices, the Fieldbus Foundation (FF), the HART Communication Foundation (HCF) and the Profibus Nutzerorganisation (PHO) have created a unified electronic device description language (Electronic Device Description Language EDDL). The EDDL, or the corresponding Electronic Device Description EDD is defined in the standard IEC 61804-2.

Besides the above described device descriptions, there are so-called Device Type Managers (DTM), or device managers or device drivers, which require as runtime environment an FDT-frame. DTMs serve for the comprehensive servicing of field devices and correspond to the FDT—Field Device Tool—Specification. The EDT-Specification, as an industrial standard, is an interface specification and was developed by the PNO—Profibus User Organisation—in cooperation with the ZVEI—Zentralverband Elektrotechnik- and Elektroindustrie (The German Electrical and Electronics Industry)—; the respective current FDT-Specification is obtainable from the ZVEI, or the PNO, or the FDT-Group.

The FDT-technology opens the opportunity for universal servicing of field devices of different manufacturers via device drivers, which run in an FDT-frame and which describe the field devices comprehensively. The terminology, servicing of field devices, is to be understood quite generally as reference to the parametering, or the configuring of field devices, as well as likewise the performing of a diagnosis of one of the field devices. In the simplest case, the servicing of a field device refers to the representing of information concerning the field device on a display.

Since, for each field device type, a corresponding device driver is required, the number of device drivers is very large. One speaks, in this connection, of a device driver library or also a DTM library. Via an installed setup of the device driver library, it is possible for a customer to service field devices of different manufacturers universally. This universal device driver library, especially one based on an interpreter device driver, is produced once and subsequently delivered to the customer, or offered for download. In this connection, it is desirable that the setups are adapted individually to the respective customers. Currently, such production of individualized setups matched to the individual customer is only possible with a correspondingly embodied setup. This means that each customer receives a tailor-made, individual copy of the device driver library, which is specially geared to the functionality of the field devices of the customer. Usually, the customer obtains the use rights desired by it in return for license payments to the manufacturer of the device driver library. For creating corresponding individual setups for the device driver library, the offeror of the device driver library must expend a lot of effort. This effort relates especially to the management and to the testing, which are connected with creating an individualized, device driver library.

An object of the invention is to provide a method permitting creation of an individualized, customer-specific setup for a device driver library.

The object is achieved by the feature that a DTM library setup is expanded automatically by earlier created, customer-specific information. The information is added-in automatically during the installation.

By means of the method of the invention, it is possible to perform a customer-specific setup of a device driver library without great effort, especially once the basic device driver library has been produced. For this, it is provided that a special (software-) tool expands the basic setup of the device driver library with suitable customer information. The method of the invention is based on individualizing device driver library setups after production of a basic device driver library setup. The individualized setup utilizes stored, customer-specific information during installation, in order e.g. to perform a license activation automatically. In this way, license activation for a customer is simplified greatly, since it is no longer necessary to input individual customer data. Preferably, license activation is implemented via an individualized device driver library setup via one of the following options:
The activation request is sent to the licensor via Internet;
The activation request is sent to the licensor via email;
The activation request is sent to the licensor via SMS.

In a preferred embodiment of the method of the invention, the tool involves the following: An MSI database is modified in such a manner that earlier assembled, customer-specific information can be entered into the MSI database. Preferably, this entry occurs automatically. The remaining content of the setup remains unchanged in the case of this further development, which has the advantage that a testing of the rest of the content of the database becomes unneccessary. An MSI database is, moreover, a component of any setup based on the tool, ‘Windows Installer’. An MSI database describes a complete installation logic in the form of a number of tables. The MSI database is a database in the classic sense. Of course, the use of a tool based on an MSI database is only a preferred and simple to implement embodiment for performing the method of the invention.

An advantageous further development of the method of the invention provides that the customer-specific information is entered automatically into the MSI database, as soon as the customer activates the downloading of the device driver library. The customer-specific information includes a unique identifier, especially an identifier of the corresponding customer.

Especially advantageously in connection with the method of the invention is when the customer-specific information, via which the device driver library setup is expanded, includes customer-specific, license information, or license configuration information. License configuration information serve to enable for a customer only the features of a field device licensed to the customer, while non licensed features are deactivated and can not be utilized by the customer. This object is achieved by means of the license activation of the invention. In such case, the customer-specific information is sent to the licensor. The licensor can then with this information automatically enable the features desired, and, respectively, licensed by the customer. This variant of the invention is especially advantageous for the customer, since the customer-specific information need subsequently no longer be input manually. Especially, the customer-specific setup is stored after the purchase, and, respectively, the licensing and is also available for later applications.

Of course, it is understood that the customer-specific information can be, for example, the customer name, the customer number or a purchase transaction of such customer.

This information is transmitted during license activation to the licensor via Internet, e-mail or SMS, wherein license activation can likewise occur via Internet, e-mail or SMS.

Especially, the method of the invention provides that through the unique identifier a unique reference to the earlier produced, individual, customer-specific information is produced in an Internet shop. In the case of this embodiment, individual customer-specific setups are assembled earlier by the manufacturer. As soon as the customer, or the user, requests the device driver library via the Internet shop and enters its individual identification, the corresponding, earlier produced, customer-specific information is associated with the requested setup. Especially, each setup is, for this, expanded by a new MST-file. An MST-file is a so-called transform file. It has only the difference data for the MSI database and can be united with the MSI database during the run time of the setup.

Furthermore, it is provided that the corresponding MST file is transmitted, preferably via Internet, after the downloading of the device driver library. For example, the MST file can be sent to the customer via email also after the download process.

Moreover, in connection with the method of the invention, it is provided that the content of the setups, such as plug-ins, functions, device types, etc. is matched individually to the specifications of the customer. In this way, it is possible, for example, to configure the device driver library such that only the needed device drivers corresponding to the customer request are integrated into the device driver library. Furthermore, an option is to activate or to deactivate other supplemental functions, such as e.g. the echo curve in the case of fill-level measuring devices, which work according to the travel time principle, corresponding to the customer's order.

Furthermore, it is provided that the customer-specific information can also be utilized for the purpose of copy protection. This opportunity should especially discourage illegal copying of device drivers, or the device driver library. For the case, in which a customer-specific device driver library setup is downloaded by a non authorized person, the expansion means that information concerning the authorized user will be there. Thus, there is the opportunity to prove that the setup, in given cases, occurred without authorization, namely when the device driver library with the customer-specific information of the authorized user is found in the possession of an unauthorized user. Thus, the copy protection permits a non-visible deterrent against illegal copying of device driver libraries.

The invention will now be explained in greater detail based on the appended drawing, the figures of which show as follows:

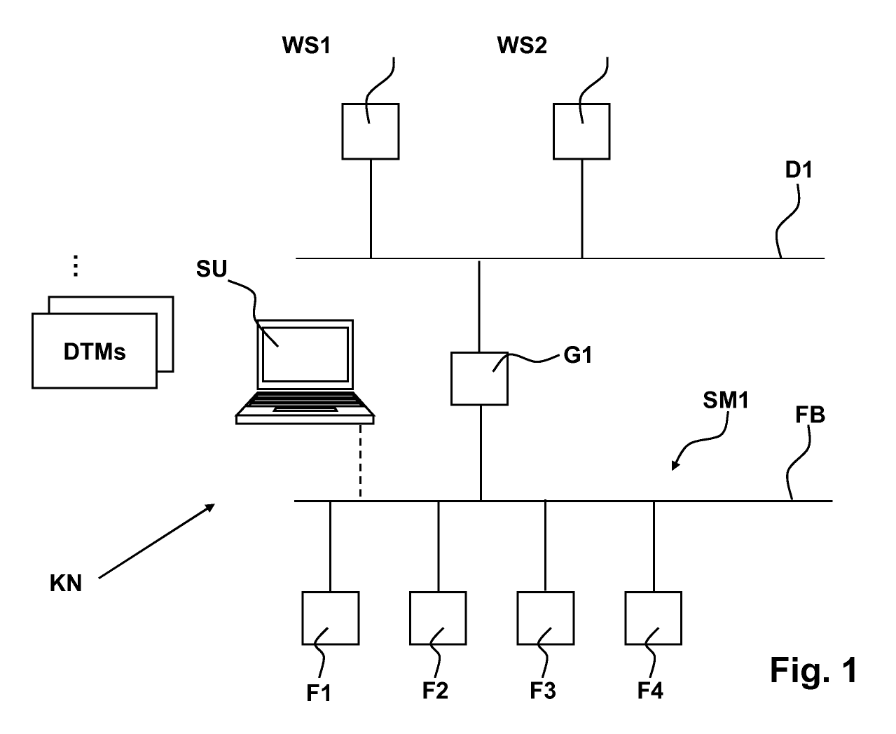

FIG. 1 a schematic representation of a communication network KN, such as is applied, for example, in process automation;

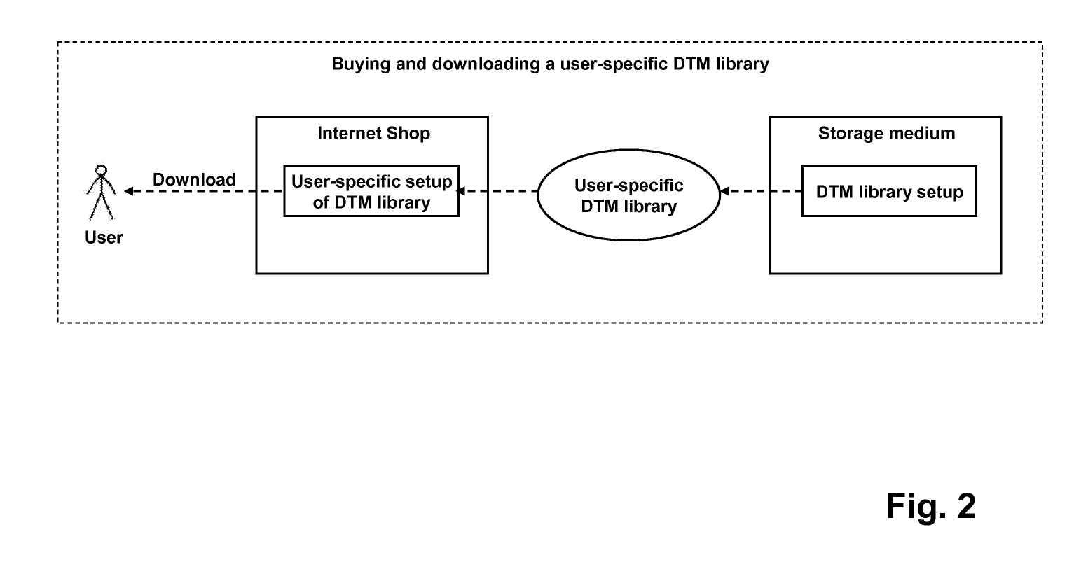

FIG. 2 a schematic representation of a first embodiment of the method of the invention,

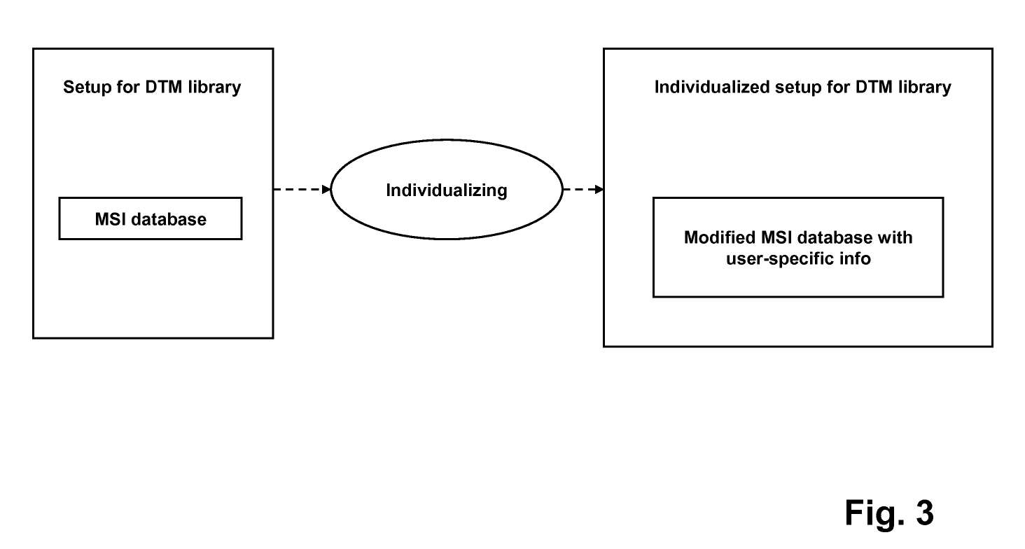

FIG. 3 an embodiment of the method of the invention illustrating how a customer-specific setup is created, and

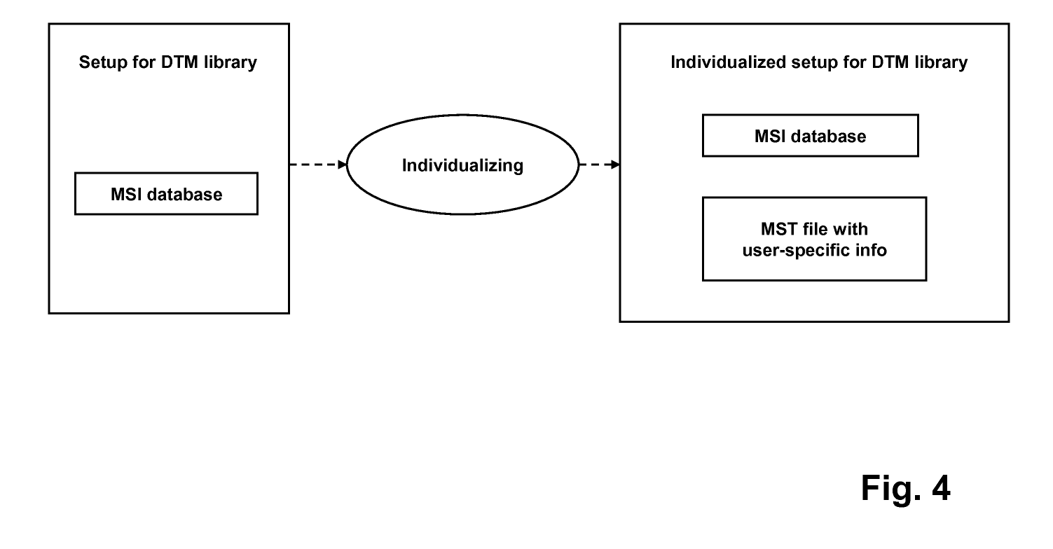

FIG. 4 another representation of an embodiment of the method of the invention illustrating how a customer-specific setup is created.

FIG. 1 shows schematically a communication network KN, such as used, for example, in process automation. Connected here to a data bus D1 of the control level are a number of control units (workstations, host-computers, or, generally, clients) WS1, WS2. These control units WS1, WS2 serve as superordinated units, or control structures (control system, master control, control unit, service unit SU) for process visualizing, process monitoring and for engineering, however, also for servicing and monitoring of field devices F1, F2, F3, F4. Of course, as a function of the size of the communication network KN, just one of the control units WS1; WS2; SU can be sufficient. Likewise, the service unit SU, e.g. the operating, or servicing, tool, FieldCare, of the Endress+Hauser group, can be arranged at the control system level or on the field plane.

In the illustrated case, the data bus D1 is a high speed data bus, on which data are transmitted with high transmission rates. The data bus D1 works, for example, according to the Profibus® DP standard, the HSE “High Speed Ethernet”—standard of FOUNDATION Fieldbus®, the HART standard or some other known standard used in automation technology. Moreover, communication on the data bus D1 can also occur via TCP/IP. For the purpose of protocol conversion, in the illustrated case, the control unit WS1, WS2, SU is connected with the fieldbus segment SM1 via a gateway G1, which is also referred to as a linking device or segment coupler. Of course, depending on the architecture of the communication network KN, the superordinated control unit can also communicate directly with the field devices of the fieldbus plane.

The fieldbus segment SM1 has a plurality of field devices F1, F2, F3, F4, which, in the shown case, communicate with one another via a relatively slow fieldbus FB, e.g. HART, Profibus PA, Fieldbus Foundation, etc. The field devices F1, F2, F3, F4 are sensors and/or actuators or other process-near components accessible via a fieldbus D; FB. Corresponding field devices F1, F2, F3, F4 are described at length in the introduction above. Connected, or connectable, by wire or wirelessly, with the fieldbus FB, usually temporarily, is a portable service unit SU, e.g. a laptop, a PDA, a Palm, a cell phone or some other operating element. Via this service unit SU, operating personnel have access to the individual field devices F1, F2, F3, F4 virtually in the bypass method.

FIG. 2 shows a schematic representation of an embodiment of the method of the invention. The device driver library/DTM library is made available to the customer via a web server via Internet.

On the service unit SU for the field devices F1, F2, . . . of a customer, a setup of a customer-specific device driver library, DTM library, is to be installed. For this, the device drivers DTM1, DTM2, . . . of the corresponding field devices F1, F2, . . . of the customer are expanded during installation automatically by earlier assembled, customer-specific information. In this way, a customer-specific setup of the device driver library is achieved.

As shown in FIG. 3, according to a first embodiment, for creating a customer-specific setup, an MSI database is correspondingly modified. Preferably, this modification occurs in such a manner that the earlier created customer-specific information, which is contained in an MST file, is automatically entered into the MSI database, as soon as the customer, or the user, activates the downloading of the device driver library. For this, the customer-specific information includes a unique identifier, especially an identification number, for the corresponding customer. The customer-specific information can include, as a unique identifier, for example, the customer name and/or a license configuration for the corresponding customer.

Through the unique identifier, a unique reference to the customer-specific information earlier produced in an Internet shop is produced. For this, customer-specific setups are produced earlier, wherein each individual setup is assigned a unique identifier and wherein a new MST file is associated with each setup. The unique identifier is assigned to the setup of the respective customer in the Internet shop software during the downloading of the device driver library. Alternatively, it is provided in FIG. 4 that the corresponding MST file is transmitted, preferably via Internet or via email, after the downloading of the device driver library. As soon as a setup, and, respectively, an installation of the device driver library is performed, the customer-specific information is automatically taken into consideration.

1-11. (canceled)

12. A method for creating a customer-specific setup for a library of device drivers, wherein each device driver is a software module, via which a field device, or a field device type can be serviced, comprising the steps of:
automatically expanding a device driver library setup by earlier assembled, customer-specific information.

13. The method as claimed in claim 12, wherein:
an MSI database is modified in such a manner that earlier created, customer-specific information can be entered.

14. The method as claimed in claim 13, wherein:
the customer-specific information is entered into the MSI database as soon as the customer activates the downloading of the device driver library.

15. The method as claimed in claim 12, wherein:
the customer-specific information includes a unique identifier, especially an identification number, for the customer.

16. The method as claimed in claim 12, wherein:
the customer-specific information includes a unique identifier, especially the customer name and/or a license configuration for the customer.

17. The method as claimed in claim 16, wherein:
the customer-specific information is transmitted during license activation automatically to the licensor via the Internet, via email or via SMS; and
license activation occurs preferably also via the Internet, via email or via SMS.

18. The method as claimed in claim 12, wherein:
the customer-specific information is used for copy protection.

19. The method as claimed in claim 15, wherein:
through the unique identifier, a unique reference to customer-specific information assembled earlier in an Internet shop is produced.

20. The method as claimed in claim 12, wherein:
customer-specific setups are produced earlier;
a new unique identifier is assigned to each individual setup and a new MST file is associated with each setup; and
the unique identifier is assigned to the customer in the Internet shop software during downloading of the device driver library.

21. The method as claimed in claim 20, wherein:
the corresponding MST file is transmitted, preferably via the Internet, after downloading of the device driver library (DTM library).

22. The method as claimed in claim 12, wherein:
the content of the setups, such as plug-ins, functions, device types, etc., is matched individually to the specifications of the customer.
